(19) United States
(12) Patent Application Publication
(10) Pub. No.: US 2011/0105159 A1
(43) Pub. Date: May 5, 2011

(54) DIGITAL SIGNAGE SYSTEM AND IMAGE DISPLAY CONTROL METHOD

(75) Inventor: KOJI HIRAYAMA, Yokohama (JP)

(73) Assignee: Hitachi, Ltd.

(21) Appl. No.: 12/858,017

(22) Filed: Aug. 17, 2010

(30) Foreign Application Priority Data
Nov. 5, 2009 (JP) 2009-253748

(51) Int. Cl. H04W 4/12

(52) U.S. Cl. 455/466

(57) ABSTRACT

Communication terminals are used as display devices of contents. One of plural communication terminals inputs display control information for controlling the contents displayed on the communication terminals and arrangement position information of the communication terminal of control object, and transmits the information to an SMS server. The SMS server has a connection destination information storage area storing the arrangement position information of the plurality of communication terminals associated with telephone numbers of the communication terminals. The SMS server acquires one or more corresponding telephone numbers by referring to the storage area based on the arrangement position information. The SMS server creates a short-message including the display control information, and transmits it to the communication terminal with the acquired telephone number as a destination. The communication terminal controls the display of the contents in accordance with the display control information included within the received short-message.

### CLAIM OF PRIORITY

The present application claims priority from Japanese patent application JP 2009-253748 filed on Nov. 5, 2009, the content of which is hereby incorporated by reference into this application.

### BACKGROUND OF THE INVENTION

1. Field of the Invention

The present invention relates to a digital signage system and an image display control method, and more particularly to a video distribution system, including mainly a digital signage system.

2. Description of the Related Art

With the development of digital technologies, the transition from the conventional outdoor electronic advertisement such as a neon tube to the digital signage that allows more complex advertisement display in combination of a personal computer and a liquid crystal or plasma thin-type display terminal has begun. However, most control methods for more complex advertisement displays using a plurality of display terminals involve simply taking the synchronization between the terminals (e.g., refer to JP-A-2008-252422).

### SUMMARY OF THE INVENTION

In the above digital signage device, a screen control method in combination of a master machine that normally controls the overall synchronization and contents display and a slave machine that follows a control instruction from the master machine is mainstreamed.

With this control method, if a trouble occurs in the master machine, its influence extends to the overall system, whereby there is a problem that the overall system shuts down in the worst case.

Also, most of the synchronizing means are of the time synchronization type, in which a plurality of display terminals synchronizes the time between the terminals to synchronously reproduce the contents on the display screens of the display terminals. For example, if a reproduction start time set for every contents is reached, the concerned display terminal reproduces the contents at the same time. However, if a general-purpose personal computer (hereinafter abbreviated as a PC) is employed as the display terminal, the synchronization precision depends on the precision of an internal clock provided for the PC, resulting in a problem that the synchronous reproduction at high precision can not be realized. To avoid this problem, there is a method for synchronizing the time using a general-purpose time synchronization technique such as an Network Time Protocol (NTP) client built in the standard operating system (UNIX (registered trademark in Japan), MS-Windows (registered trademark in Japan), etc.), in which there is another problem that if there is a great time lag, it takes too much time until the completion of correction.

In the light of the above-mentioned problems, it is an object of the invention to realize a digital signage system and an image display control method with a plurality of display units using the existent network and server. It is another object of the invention to provide a digital signage system and an image display control method in which a network connecting a plurality of PCs is constructed, it is unnecessary to install a control device, and an introduction work can be saved.

It is a further object of the invention to minimize the influence at the time of a system trouble by providing each of a plurality of display terminals with a function of master machine and slave machine. Also, it is another object of the invention to realize a digital signage device capable of attaining display effects with high representation power by having the above function. It is another object of the invention to realize the synchronous reproduction at high precision by realizing the time synchronization that is simpler and more precise than the general time synchronization such as an NTP client employing a time signal from a Global Positioning System (hereinafter GPS) satellite for use in a mobile communication network and a time synchronization function for a mobile communication network mobile terminal (hereinafter abbreviated as a mobile terminal).

To solve the above-mentioned problems, a mobile terminal is employed as a display terminal in the invention. Further, the mobile terminal internally comprises a time synchronization function, a display control function of a master machine and a slave machine programmed in cooperation with a Short-Message Service server (hereinafter abbreviated as an SMS server), a function of transmitting and receiving an SMS message text describing various kinds of control information including the display start and stop times, and a function of storing it.

The mobile terminal receives a time signal from the GPS via the mobile communication network to synchronize the internal clock of the mobile terminal with the GPS time at the time of starting the communication access such as turning on the power, the Registration, starting the speech and transmitting or receiving the mail. This is performed at all the mobile terminals, so that the time synchronization between the mobile terminals is assured at very high precision. The internal program makes the display control based on the time of the internal clock by analyzing the content of received SMS message text and acquiring the control information on the display.

Further, though the mobile terminal can transmit the SMS message in which the display control information is described to the SMS server and receive it from the SMS server, this function and the communication function are the standard functions provided for the mobile terminal, and not described in detail.

The SMS server of the invention has a connection destination information table storing the terminal number indicating the telephone number, locus and detailed position at the locus of the mobile terminal for use in the digital signage, in addition to an SMS function originally provided. Also, the SMS server has a function of speeding up the transmission of SMS messages to a plurality of mobile terminals installed on the mobile communication network and collecting the information from the plurality of mobile terminals and an area for recording the information.

Also, the invention provides a method for making the connection to the plurality of mobile terminals connected on the mobile communication network using the SMS server, information transmission and display control, including broadcasting and transmitting the representation control information for the contents displayed at the plurality of mobile terminals based on the information of the connection destination information table registered by the SMS server, whereby a high function display can be realized on a plurality of screens.

According to the first solving means of this invention, there is provided a digital signage system using a plurality of communication terminals for displaying contents and a message server for providing a message service via a mobile communication network to the communication terminals, wherein:

the message server has a connection destination information storage area storing arrangement position information according to an arrangement position at which a communication terminal is arranged associated with a telephone number or address information of the communication terminal;

one of the plurality of communication terminals inputs control information including display control information for controlling the contents displayed on the plurality of communication terminals and the arrangement position information of the communication terminal being a control object, and transmits the control information to the message server,

the message server acquires one or more corresponding telephone numbers or address information by referring to the connection destination information storage area based on the arrangement position information within received control information, creates a message including the display control information within the received control information, and sets the acquired telephone number or address information as a destination of the message and transmits the message to the communication terminal; and

the communication terminal controls the display of the pre-stored contents in accordance with the display control information included in the received message.

As a result, a digital signage system with a plurality of display devices can be realized using the existent network and server. Also, it is possible to provide a digital signage system in which a network connecting a plurality of PCs is constructed, it is unnecessary to install a control device, and an introduction work can be saved. Further, each of a plurality of mobile terminals has a master machine function, whereby it is possible to avoid the entire break-down of a digital signage system itself due to a system trouble caused by the master machine.

The above message server can be a server providing a short-message service.

Thereby, it is possible to provide the control information of the contents display on the mobile terminal selected from the plurality of registered mobile terminals through an SMS message. Also, since the SMS message is communicated using a signaling channel, the transmission of the control information to the plurality of mobile terminals can be realized with a relatively small data delay.

Also, in the above digital signage system, each of the plurality of communication terminals has an internal clock with the time GPS synchronized.

In the invention, each mobile terminal receives a GPS time signal through the mobile communication network and makes the time correction, thereby assuring the time synchronization between the mobile terminals, and if each display terminal displays the contents in accordance with the contents display control information held by each mobile terminal with the synchronous time as the basic time, the contents display synchronous on a plurality of display screens can be made.

According to the second solving means of this invention, there is provided an image display control method for use in a digital signage system for displaying contents using a plurality of display terminals, in which a plurality of communication terminals are used as the plurality of display terminals for displaying the contents, the method including:

inputting control information including display control information for controlling the contents displayed on the plurality of communication terminals and arrangement position information of the communication terminal being a control object, and transmitting the control information to a message server for providing a message service via a mobile communication network, by one of the plurality of communication terminals;

acquiring one or more corresponding telephone numbers or address information by referring to a connection destination information storage area storing arrangement position information according to an arrangement position at which a communication terminal is arranged associated with the telephone number or address information of the communication terminal, based on the arrangement position information within received control information, by the message server;

creating a message including the display control information within the received control information;

setting the acquired telephone number or address information as a destination of the message and transmitting the message to the communication terminal; and

controlling the display of the pre-stored contents in accordance with the display control information included in the received message by the communication terminal.

According to the invention, it is possible to realize a digital signage system and an image display control method with a plurality of display units using the existent network and server. According to the invention, it is possible to provide a digital signage system and an image display control method in which a network connecting a plurality of PCs is constructed, it is unnecessary to install a control device, and an introduction work can be saved.

### BRIEF DESCRIPTION OF THE DRAWINGS

FIG. 1 is a system configuration view of a system according to this embodiment.

FIG. 2 is an explanatory concept view of GPS time synchronization according to this embodiment.

FIG. 3 is an explanatory concept view of an http synchronous message between the mobile terminal and an SMS server according to this embodiment.

FIG. 4 is an explanatory concept view (basic operation view) of an SMS synchronous message between the mobile terminal and the SMS server according to this embodiment.

FIG. 5 is an explanatory concept view (applied operation view) of the SMS synchronous message between the mobile terminal and the SMS server according to this embodiment.

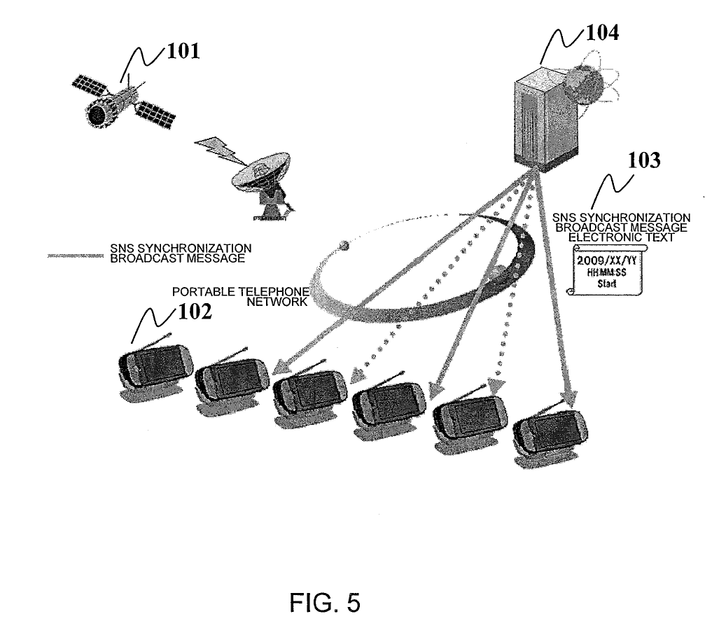

FIG. 6 is an organizational view of a connection destination information table 600 within the SMS server 104.

FIG. 7 is a view showing an example (basic operation) of a message syntax 700 for the http synchronous message and the SMS synchronous message between the mobile terminal and the SMS server according to this embodiment.

FIG. 8 is a view showing an example (applied operation) of a message syntax 800 for the http synchronous message and the SMS synchronous message between the mobile terminal and the SMS server according to this embodiment.

FIG. 9 is a sequence chart of the http synchronous message and the SMS synchronous message between the mobile terminal and the SMS server according to this embodiment.

FIG. 10 is a block diagram of the mobile terminal.

FIG. 11 is an overall flowchart of a process according to this embodiment.

FIG. 12 is a schematic flowchart of a transmission process at the mobile terminal.

FIG. 13 is a schematic flowchart of a process in the SMS server.

FIG. 14 is a schematic flowchart of a receiving process at the mobile terminal.

### DESCRIPTION OF THE PREFERRED EMBODIMENTS

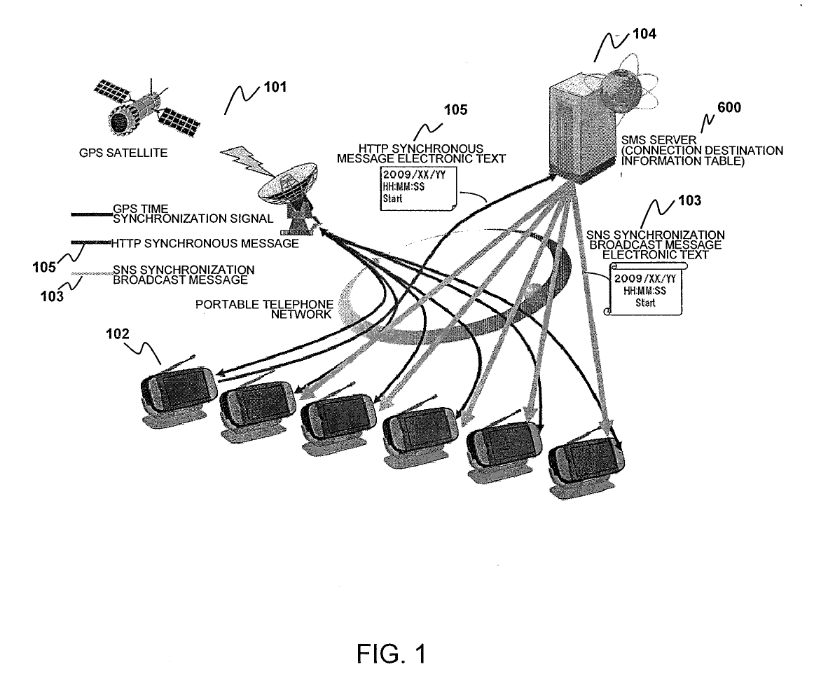

FIG. 1 is a system configuration view of a digital signage system according to this embodiment.

This system comprises a mobile terminal (communication terminal) 102 for displaying contents information, an SMS server 104 installed on a mobile communication network, and a GPS system 101 for receiving a GPS time signal from a GPS satellite. The mobile terminal 102 is provided with software for creating and reading an SMS message. Further, the portable telephone 102 is also provided with a Web browser function of transmitting and receiving the information in accordance with an http protocol. The SMS server 104 has a connection destination information table 600.

For example, a plurality of mobile terminals 102 are installed at any locations. In FIG. 1, they are installed at locations with “omori”, for example, as identification information. For example, the mobile terminals may be installed in parallel, or separately.

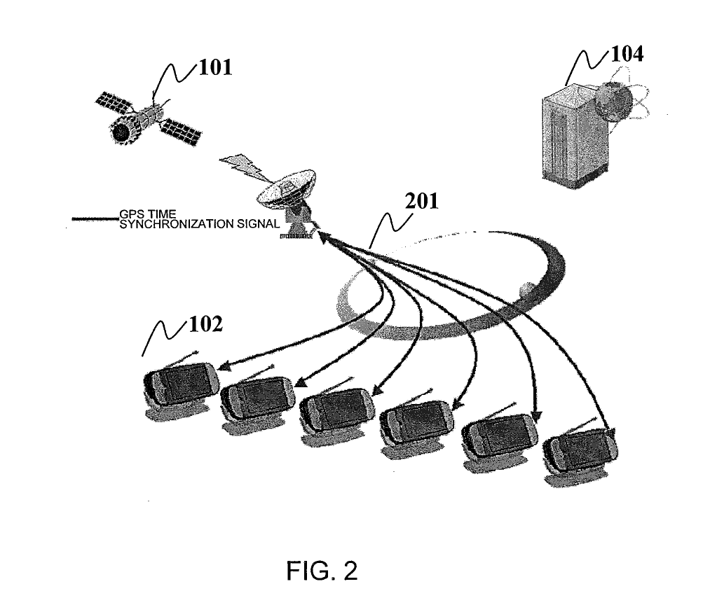

FIG. 2 is a concept view in which the mobile terminal 102 is time synchronized with a GPS synchronization time signal in the digital signage system according to this embodiment.

The mobile terminal 102 receives a time synchronization signal 201 from the GPS through the communication network at the time of starting the communication access such as turning on the power, registering the position, starting the speech or transmitting or receiving a mail. The GPS time synchronization signal 201 is generated from the information of a very accurate atomic clock that the GPS satellite contains, its accuracy being always monitored and corrected by the Pentagon. The mobile terminal 102 corrects the time of an internal clock of the mobile terminal 102 for the GPS time, based on the time information obtained by this GPS time synchronization signal 201.

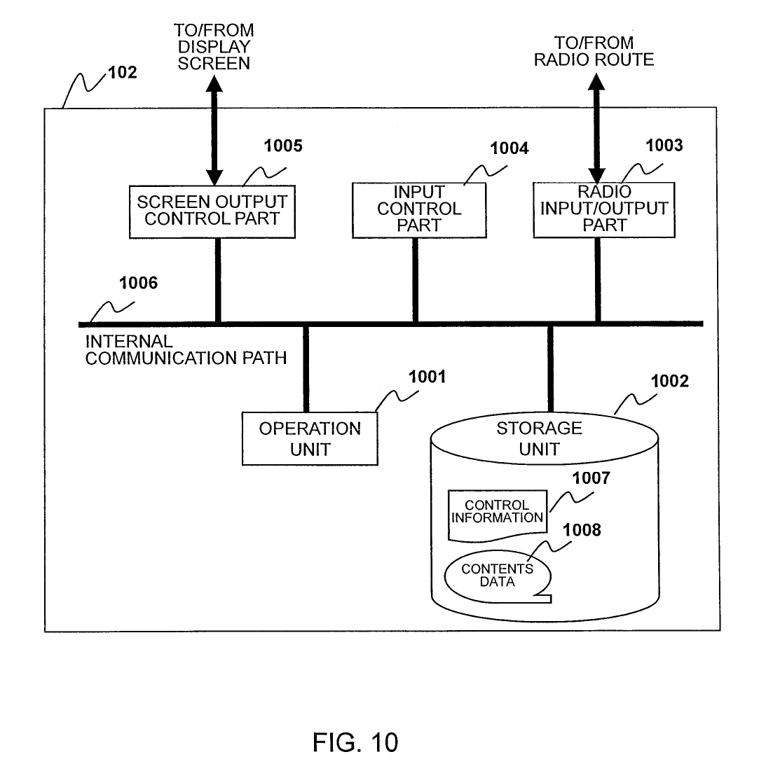

FIG. 10 is a functional block diagram of the mobile terminal 102.

The mobile terminal 102 has an operation unit 1001 for controlling the overall device, a storage unit (a display control information storage part, a video data storage part) 1002 for reading and writing information from each functional block, a screen output control part 1005 for controlling screen output information to the screen of the mobile terminal, or an external display unit, an input control part 1004 for controlling input information delivered from a button of the mobile terminal 102, a radio input/output part 1003 for controlling communication between the mobile terminal 102 and the mobile communication network, and an internal communication path 1006 for transferring the information of each functional block. The storage unit 102 has internally display control information 1007 and the contents data 1008. The mobile terminal 102 may further comprise a synchronization part for synchronizing the time and an internal clock, or the operation unit may comprise them. The mobile terminal 102 may be provided with the display screen.

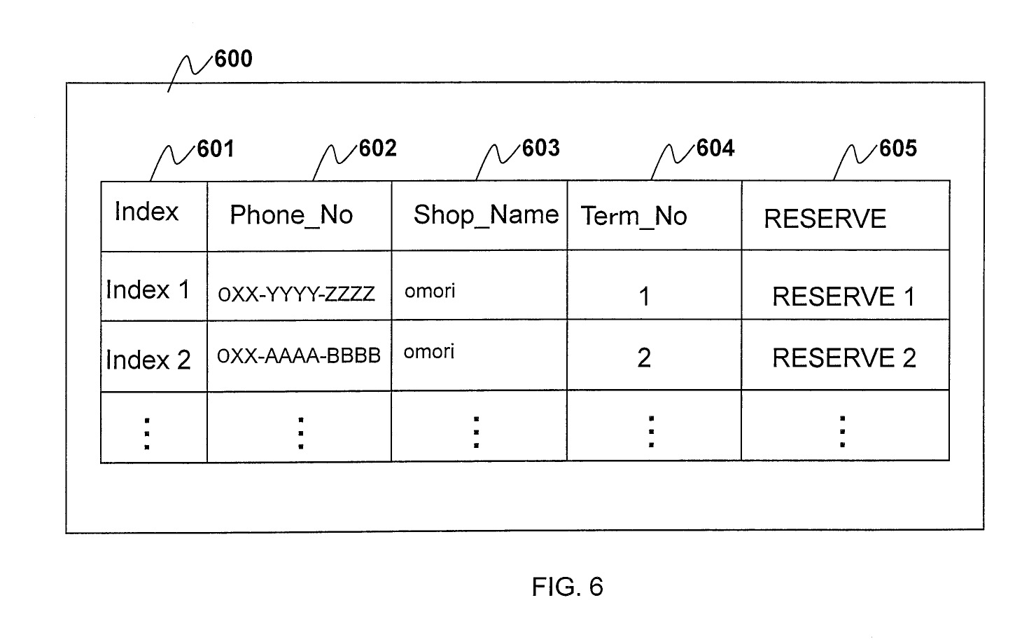

FIG. 6 is an organizational view of the connection destination information table 600 within the SMS server 104.

The connection destination information table 600 is a data table having the areas of an Index 601, a Phone_No 602 for storing the telephone number of the registered mobile terminal 102, a Shop-Name (location information) 603 for storing the installed location information of the mobile terminal 102, a Term_No 604 indicating the arrangement order (array information), and a reserve 605 for storing information considered for the further use. The reserve 605 may be omitted. The Index 601 is identification information for the entries (a set of the Phone_No 602, the Shop_Name 603, the Term_No 604 and the Reserve 605) in the connection destination information table 600, such as the sequential number or character, for example. The Index 601 may be omitted. The mobile terminal 102 is specified by the Shop_Name 603 and the Term_No 604. For example, the Shop_Name 603 designates the shop, facility or area where the mobile terminal 102 is installed, and the Term_No 604 designates the number corresponding to the arrangement position or array position obtained when the mobile terminals 102 are arranged in a predetermined array. Each information can be pre-stored in accordance with the arrangement of the mobile terminals 102.

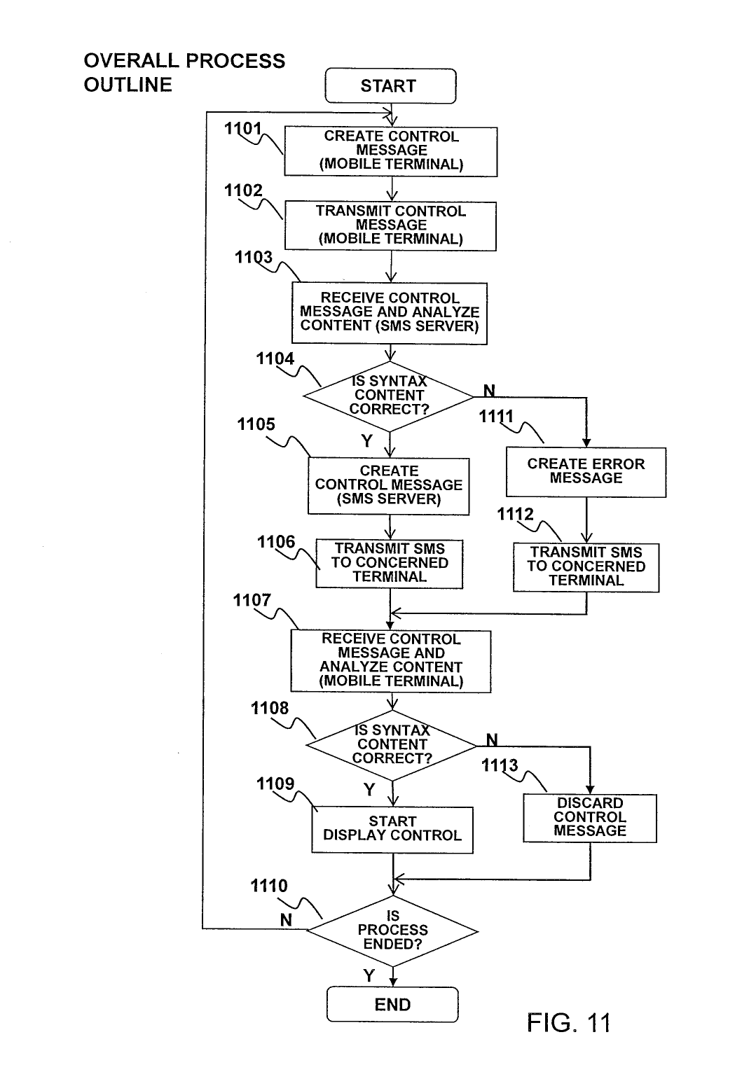

FIG. 11 is an overall flowchart of a process according to this embodiment.

The process of this embodiment includes creating and transmitting a control message at the mobile terminal 102, receiving the control message in the SMS server 104, analyzing the contents, creating the control message, receiving the control message from the SMS server 104 at the mobile terminal 102, analyzing the contents, and making the display control, for example.

The outline of all the process will be described below in accordance with the flowchart of FIG. 11. The details of each step will be described later.

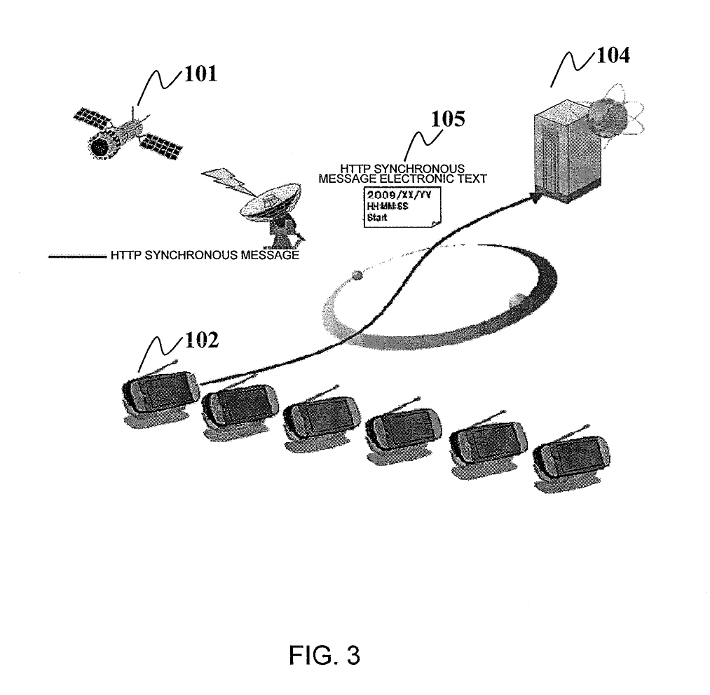

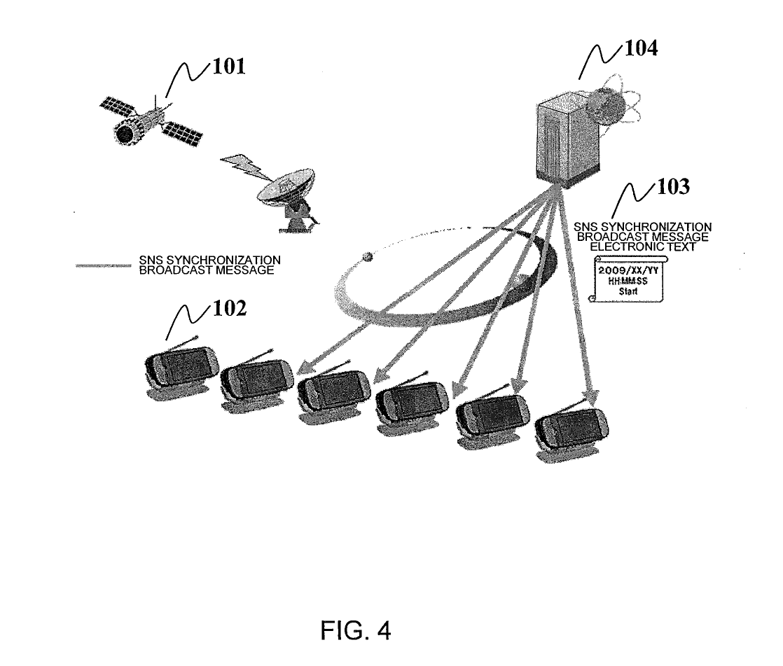

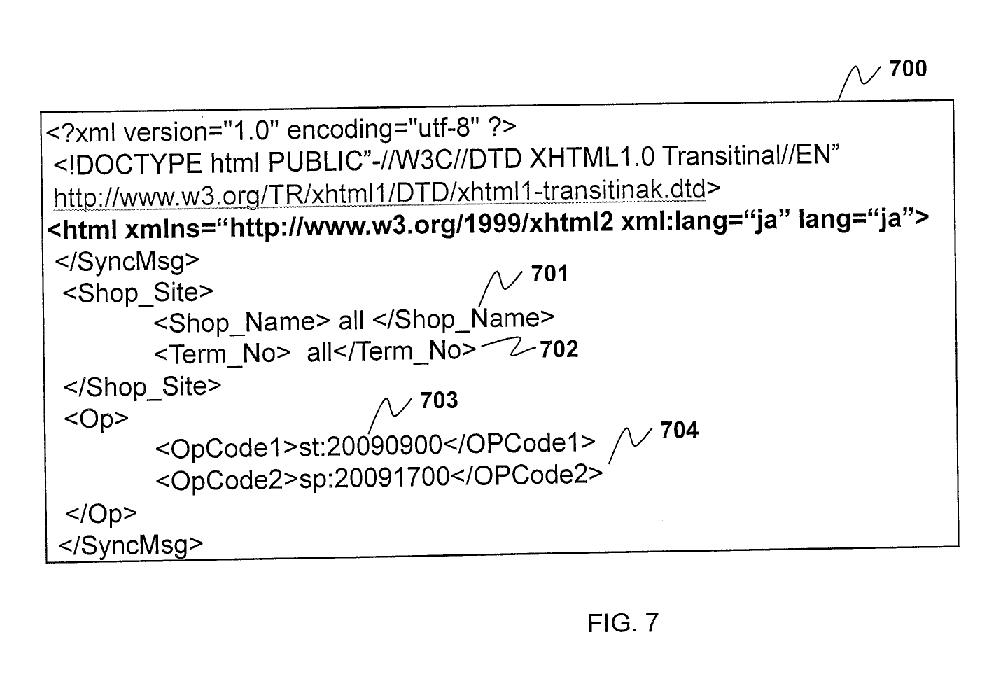

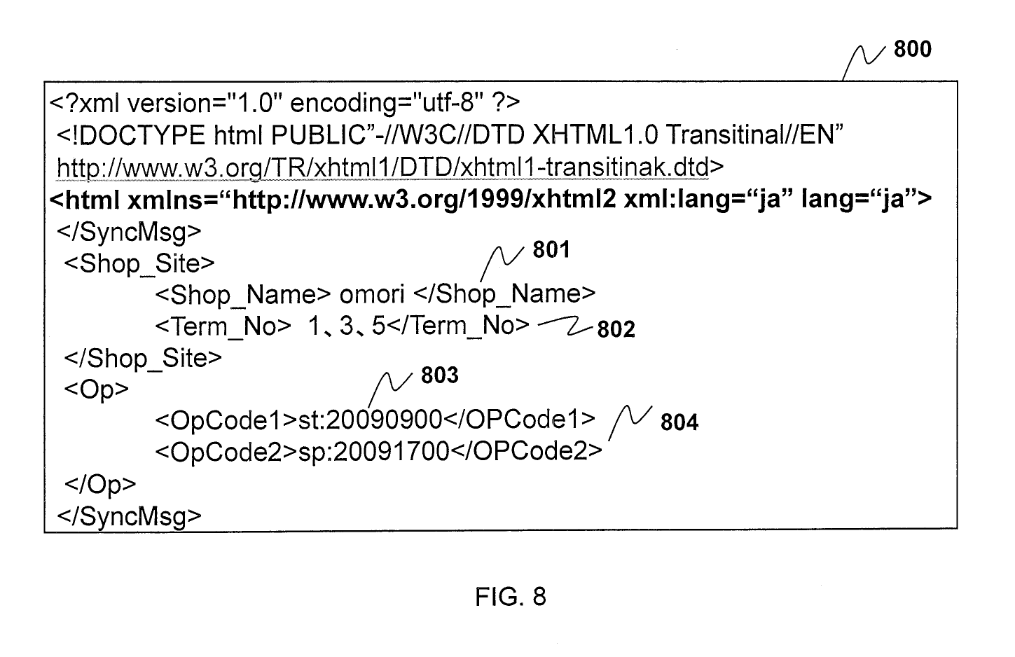

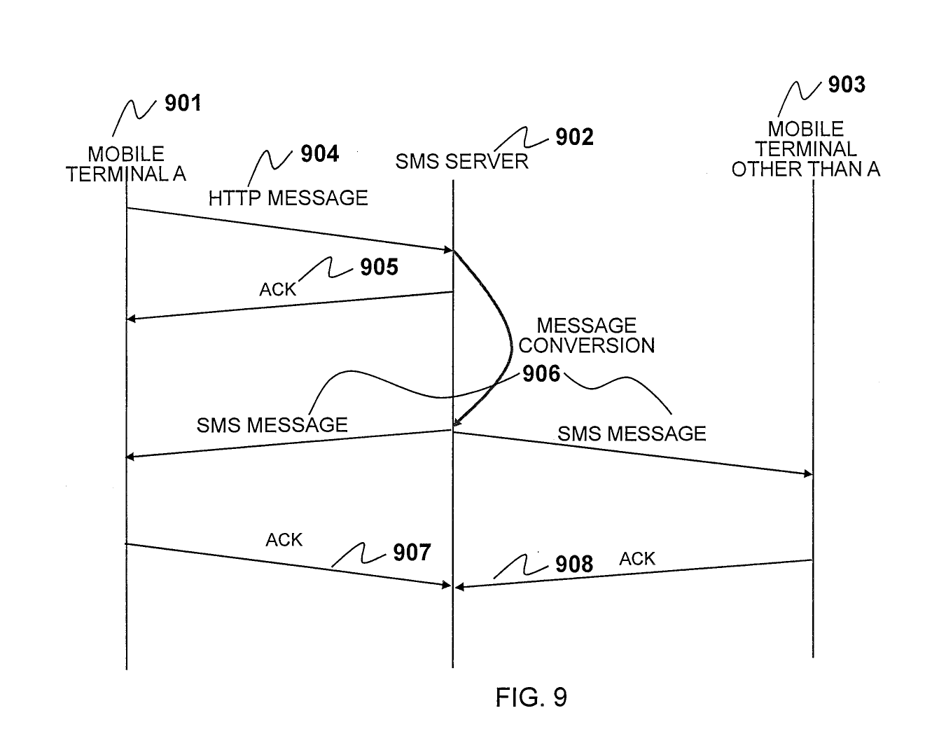

The mobile terminal 102 (e.g., operation unit 1001, the same holds in the following) converts information to be controlled into the control message (e.g., 700 of FIG. 7 or 800 of FIG. 8, hereinafter simplified as 700) (1101), and then judges whether or not to transmit it to the SMS server (1102). This mobile terminal may be any of the plurality of mobile terminals 102. For the transmission to the SMS server, for example, an http protocol message is transmitted to the SMS server 104 by the mobile terminal 102 (FIG. 3, 904 of FIG. 9). The SMS server 104 receives the control message from the mobile terminal 102 and analyzes the description content of the control message 700 (1103). In the SMS server 104, if it is judged that the description content of the control message 700 is correct (no error) (1104), the control message 700 is converted into the SMS message (1105). After converting the control message 700, the SMS message is transmitted to the concerned mobile terminal 102 in accordance with the corresponding telephone number by collating the mobile terminal 102 of control object described in the control message 700 with the mobile terminal 102 described in the internal connection destination information table 600 (1106, FIG. 4, 906 of FIG. 9). On the other hand, if it is judged that the description content of the control message 700 is incorrect (error) at step 1104, the control message 700 indicating the deficiency of the description content is created, and converted into the SMS message (1111). After conversion, the SMS message is transmitted to the mobile terminal 102 receiving the control message 700 (1112). Each terminal server transmits Ack properly upon receiving the message (905, 907 and 908 of FIG. 9).

Next, one or more mobile terminals 102 receiving the SMS message convert the SMS message into a format of the control message 700 and analyze the control content (1107). If it is judged that the description content of the control message 700 is correct (no error) (1108), the mobile terminal 102 properly stores the control information of the control message 700, and makes display control for starting display at a certain time or stopping display at a certain time, for example, based on the control information (1109). On the other hand, if it is judged at step 1108 that the description content of the control message 700 is incorrect (error), the received control message 700 is discarded (1113). At this time, the mobile terminal 102 continues the display control based on display control information received in the past or held from the beginning of operation.

The mobile terminal 102 judges whether or not to continue the above process (1110), and if so, subsequently waits for the processing at step 1101. On the other hand, if not, all the processes are ended.

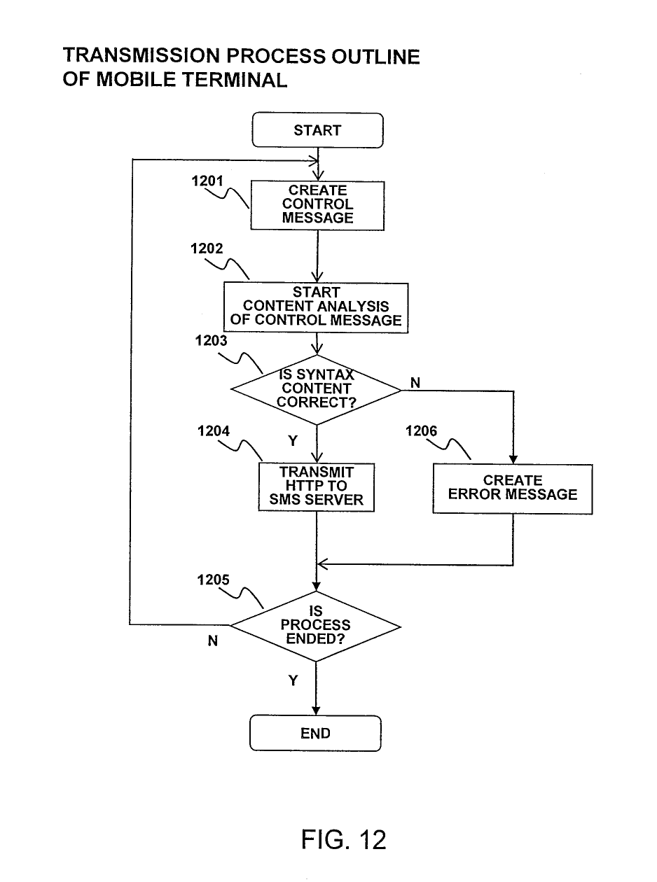

FIG. 12 is a flowchart of a control message transmission process at the mobile terminal 102.

This flowchart corresponds to steps 1101 and 1102 of FIG. 11. Firstly, the processes for creating the control message (1201) and transmitting the control message (1202) will be described below in detail.

The mobile terminal 102 inputs information to be controlled, for example, control information to start the display of the contents at a certain time, stop the display at a certain time, control only the mobile terminal 102 in a certain area (location), or control only the specific mobile terminal 102 in a certain area. More specifically, the mobile terminal 102 inputs the terminal specific information (Shop Site: FIG. 7) for specifying a terminal to be controlled and the operation information (Op: FIG. 7) for controlling the display screen, for example. The terminal specific information can include the location information (Shop_Name) and the array information (Term_No). Also, the operation information can include the start time (st) and the stop time (sp). These pieces of information may be inputted from the input part such as a button for the mobile terminal 102, or from an external device connected to the mobile terminal 102, or read from a storage medium pre-storing these pieces of information and connected to the mobile terminal 102.

The mobile terminal 102 creates the control message from the input control information, but on this occasion adopts, for example, an eXtensible Markup Language (hereinafter abbreviated as an XML) for the control message itself. The XML had its basic specifications XML1.0 drawn up in a W3C (World Wide Web Consortium) in February, 1998, to make it easier to use in the internet a Standard Generalized Markup Language (SGML) standardized by the ISO in 1886. A HyperText Markup Language (HTML) that is a Web page creation language has a tag fixed, with a structure specific to the display, and has a problem that the requirement to perform the program processing based on the tag information from an application can not be dealt with. On the contrary, the XML has a language structure that a user can define the tag freely, and give meaning to the character string in the document, and has a merit that the XML data can be freely information processed in the program. Moreover, in the XML, the language specifications are defined by omitting complex printing system options for the SGML, with a merit that it is easier to understand and more user-friendly.

The examples of the XML message generated at the portable telephone 102 are shown in FIG. 7 (700) and FIG. 8 (800). In this embodiment, tag information (701 to 704, 801 to 804) has the same meaning as each column of the connection destination information table 600 within the SMS server 104, but is unnecessary to be particularly matched with each column information of the connection destination information table 600. Next, the mobile terminal 102 analyzes the content of the control message 700 (1202). In this embodiment, the description content of each tag information is confirmed in accordance with the syntax rules of the XML. For example, it is checked if there is a syntax error or an error that the time information is unrealistic, or in the past. Next, if there is no error in the control message 700 (1203), the mobile terminal 102 stores the control message 700 as the http protocol message text and transmits the http protocol message to the SMS server 104 (1204). On the other hand, if there is any error in the control message 700 (1203), the mobile terminal 102 creates an error message (1206). Finally, the mobile terminal 102 judges whether or not to continue the above process (1205), and if so, subsequently waits for the processing at step 1201. On the other hand, if not, all the processes are ended. Whether or not the process is continued may be properly decided by inputting an instruction from the input part.

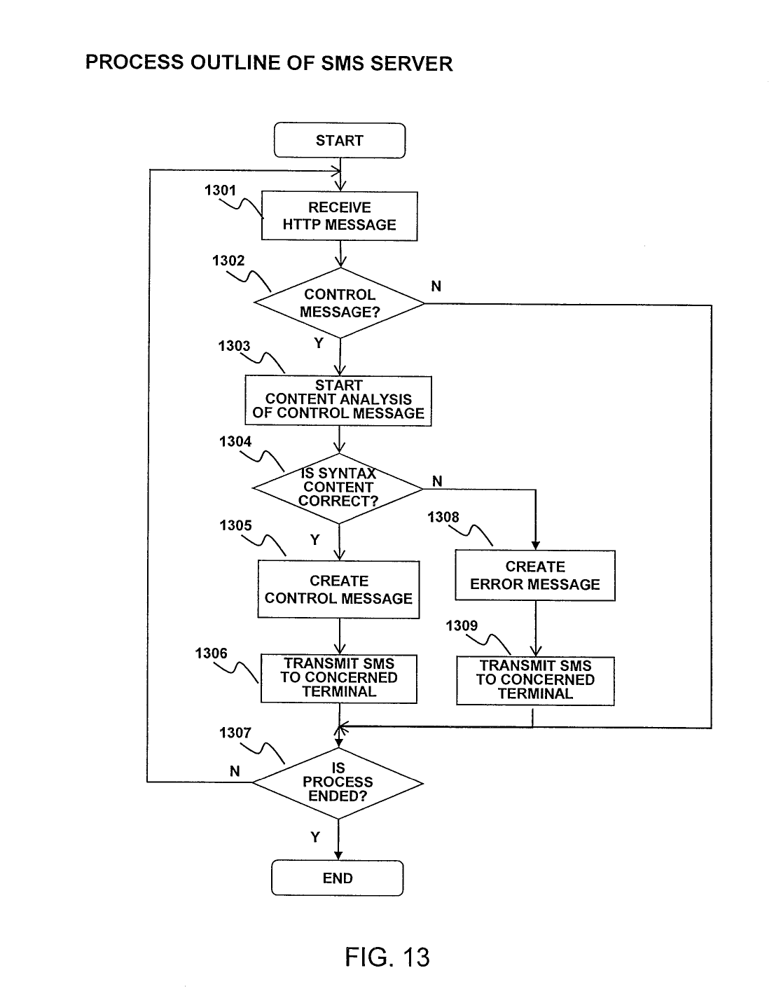

FIG. 13 is a flowchart of a control message process in the SMS server 104.

This flowchart corresponds to steps 1103 to 1106, 1111 and 1112 of FIG. 11. Firstly, a control message receiving process (1301) in the SMS server 104 will be described below.

The SMS server 104 receives the http protocol message from the mobile terminal 102 (1301), and confirms whether or not the content stored in the http protocol message text is the control message 700 (1302). For example, an identifier indicating the control message is included in the http protocol message text, and the control message is confirmed by detecting this identifier included in the http protocol message text. In the case of the control message 700, the SMS server 104 analyzes the content of the control message 700 (1303). In this embodiment, the description content of each tag information is confirmed in accordance with the syntax rules of the XML. If there is no error in the control message 700 (1304), the SMS server 104 stores the control message 700 as the SMS message text (1305). Next, the SMS server 104 selects the sending destination information from the connection destination information table 600 stored within the SMS server to transmit the control message 700 to one or more mobile terminals 102 of control object described in the control message 700, and transmits the SMS message to the mobile terminal 102 in accordance with the sending destination information (1306). More specifically, the SMS server 104 extracts the installed location information and the array order information from the tag information (701, 702, 801, 802) described in the control message 700 or 800, and retrieves each column (603, 604) of the connection destination information table 600 with each extracted information as a key to acquire the telephone number (602) in one or more matched columns and select the sending destination. The SMS server 104 transmits the SMS message with the acquired telephone number as a destination. If there are two or more columns matched with the key, it transmits the SMS message with two or more acquired telephone numbers as the destination.

On the other hand, if there is an error in the control message 700 (1303), it creates an error message (1308). The error message is transmitted as the SMS message to the mobile terminal 102 of sender (1309). Finally, the SMS server 104 judges whether or not the above process is continued (1307), and if it is judged that the process is continued, subsequently waits for the processing at step 1301. On the other hand, if it is judged that the process is not continued, all the processes are ended.

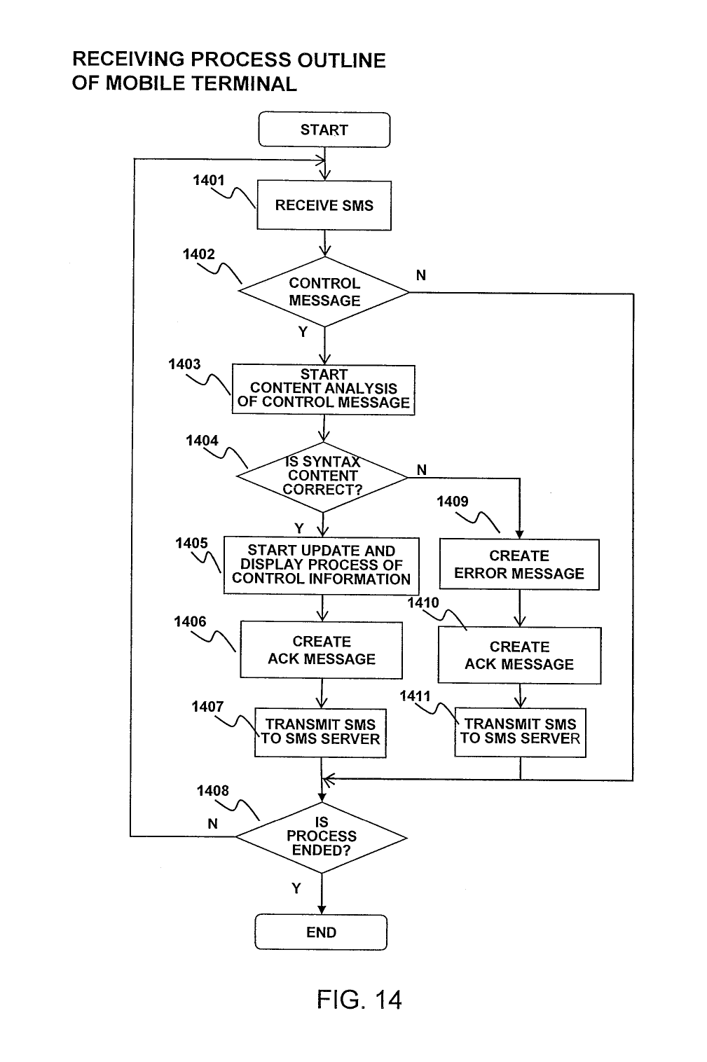

FIG. 14 is a flowchart of a control message receiving process at the mobile terminal 102.

This flowchart corresponds to steps 1107 to 1109 and 1113 of FIG. 11. This flowchart is performed in one or more mobile terminals receiving the SMS message from the SMS server 104. Firstly, a control message receiving process (1401) at the mobile terminal 102 will be described below.

The mobile terminal 102 receives the SMS message from the SMS server 104, and confirms whether or not the content described in the SMS message text is the control message 700 (1402). As one example, the control message is confirmed from the pattern by referring to a few lines of the received SMS message text. In the case of the control message 700, the mobile terminal 102 analyzes the content of the control message 700 (1403). In this embodiment, the description content of each tag information is confirmed in accordance with the syntax rules of the XML. If there is no error in the control message 700 (1404), the mobile terminal 102 updates the stored control information based on the control information of the control message, and makes the display control based on the updated control information (1405). More specifically, the control information is updated to start the display at a certain time or stop the display at a certain time, for example, based on the control information described in the tag information (703, 704) described in the control message 700 or 800. Next, the mobile terminal 102 creates an ACK message in the sense that the control information is normally received and updated (1406), and transmits it as the SMS message to the SMS server 104 (1407).

On the other hand, if the control message 700 is not confirmed (1402, No), the mobile terminal 102 recognizes it as the ordinary SMS message and performs no process of updating the control information.

Also, if there is an error in the control message 700 (1404, No), the mobile terminal 102 creates an error message indicating that the description content of the control message is erroneous (1409), creates an ACK message in the sense that the control message is normally received (1410), and transmits it as the SMS message (1411). Finally, the mobile terminal 102 judges whether or not the above process is continued (1408), and if it is judged that the process is continued, subsequently waits for the processing at step 1401. On the other hand, if it is judged that the process is not continued, all the processes are ended.

FIG. 9 shows how to exchange the message between the mobile terminal 102 and the SMS server 104 in one series of flowcharts as described above. The protocols as described herein are the http protocol and the SMS message protocol for use in the mobile communication network, which are already known, and not described in detail in this embodiment.

The process of this embodiment is regularly and periodically performed by the mobile terminal 102 and the SMS server 104, whereby it is possible to control a variety of display effects using one or more mobile terminals 102, and construct a video distribution system including a digital signage that realizes the synchronous display at high precision. Further, by carrying out this invention, it is possible to save various kinds of normal construction works including a requisite network installation work in constructing the video distribution system including the digital signage, and increase the convenience that opening is easy in the area where the mobile communication network is usable.

Moreover, in this invention, using a feature of the XML that the user himself or herself can define the tag, the tag is defined for new control other than the control information defined in FIG. 7 (700) and FIG. 8 (800), or the control information of each of two or more mobile terminals 102 that transmit the SMS message is changed, so that various screen display forms can be easily realized.

For example, a new control code, for example, a control code for controlling the blinking of an image, which is different from the control codes 703 and 704, is provided, whereby the mobile terminal 102 can be easily set up such that the image is not only displayed but also blinked newly.

Further, the control message 700 that is transmitted from the SMS server 104 to two or more mobile terminals 102 in FIG. 4 has a control code 701 describing the site information, a control code 702 describing the terminal number, a control code 703 describing the image display start time, and a control code 704 describing the image display end time. For example, if the control code 702 is set to the value in ascending order from 1 in succession from the left of the mobile terminals 102 located at the same site as that shown in FIG. 4, it is possible to obtain such an image effect that a static image flows from left to right by setting the image display start time of the control code 703 and the image display end time of the control code 704 at each mobile terminal 102 to the numerical values at a certain interval in succession from the left of the mobile terminals 102.

By defining the control code newly in the same way as described above, various image display methods can be realized.

Though the SMS server 104 is employed in this invention, it is possible to use a Multimedia Messaging Service server (hereinafter abbreviated as an MMS server) currently employed in the mobile communication network. The MMS server is a server capable of transmitting the content including the image, sound, vide and rich text in mail format, but performs basically the same operation as the SMS server in the transmission and reception to and from the mobile terminal 102, thereby performs the operation as described in this embodiment.

The connection destination information table of the MMS server can store the address information and terminal identification information, instead of the telephone number.

The invention is applicable in the field of the video distribution system, including the digital signage, for example.

What is claimed is:

1. A digital signage system using a plurality of communication terminals for displaying contents and a message server for providing a message service via a mobile communication network to the communication terminals, wherein:
the message server has a connection destination information storage area storing arrangement position information according to an arrangement position at which a communication terminal is arranged associated with a telephone number or address information of the communication terminal;
one of the plurality of communication terminals inputs control information including display control information for controlling the contents displayed on the plurality of communication terminals and the arrangement position information of the communication terminal being a control object, and transmits the control information to the message server,
the message server acquires one or more corresponding telephone numbers or address information by referring to the connection destination information storage area based on the arrangement position information within received control information, creates a message including the display control information within the received control information, and sets the acquired telephone number or address information as a destination of the message and transmits the message to the communication terminal; and
the communication terminal controls the display of the pre-stored contents in accordance with the display control information included in the received message.

2. The digital signage system according to claim 1, wherein the message server is a server for providing a short-message service.

3. The digital signage system according to claim 1, wherein the message server is a server for providing a multi-media messaging service.

4. The digital signage system according to claim 1, wherein the display control information includes display start time and display end time of the contents.

5. The digital signage system according to claim 1, wherein the arrangement position information includes location information in which the plurality of communication terminals are disposed and array information specifying the arrangement position or array position of the communication terminals at the location.

6. The digital signage system according to claim 1, wherein each of the plurality of communication terminals has an internal clock with the time GPS synchronized.

7. The digital signage system according to claim 1, wherein the communication terminal comprises:
a video data storage part for storing video data acquired from a connection destination site;
a display part for displaying the video data;
a display control information storage part for storing the display control information corresponding to the video data; and
an operation unit for reading out corresponding video data from the video data storage part based on the display control information and outputting the data to the display part.

8. An image display control method for use in a digital signage system for displaying contents using a plurality of display terminals, in which a plurality of communication terminals are used as the plurality of display terminals for displaying the contents, the method including:
inputting control information including display control information for controlling the contents displayed on the plurality of communication terminals and arrangement position information of the communication terminal being a control object, and transmitting the control information to a message server for providing a message service via a mobile communication network, by one of the plurality of communication terminals;
acquiring one or more corresponding telephone numbers or address information by referring to a connection destination information storage area storing arrangement position information according to an arrangement position at which a communication terminal is arranged associated with the telephone number or address information of the communication terminal, based on the arrangement position information within received control information, by the message server;
creating a message including the display control information within the received control information;
setting the acquired telephone number or address information as a destination of the message and transmitting the message to the communication terminal; and
controlling the display of the pre-stored contents in accordance with the display control information included in the received message by the communication terminal.

9. The image display control method according to claim 8, wherein the message server is a server for providing a short-message service.

10. The image display control method according to claim 8, wherein the message server is a server for providing a multi-media messaging service.

11. The image display control method according to claim 8, wherein the display control information includes display start time and display end time of the contents.

12. The image display control method according to claim 8, wherein the arrangement position information includes location information in which the plurality of communication terminals are disposed and array information specifying the arrangement position or array position of the communication terminals at the location.

13. The image display control method according to claim 8, wherein each of the plurality of communication terminals has an internal clock with the time GPS synchronized.

14. The image display control method according to claim 8, wherein the communication terminal:
stores video data acquired from a connection destination site;
stores the display control information corresponding to the video data; and
reads out stored video data corresponding to the display control information and outputting the data to the display part for displaying the video data.
